(19) United States
(12) Patent Application Publication
(10) Pub. No.: US 2020/0186786 A1
(43) Pub. Date: Jun. 11, 2020

(54) Calibration for Augmented Reality

(71) Applicant: Novarad Corporation, American Fork, UT (US)

(72) Inventors: Wendell Arlen Gibby, Mapleton, UT (US); Steven Todd Cvetko, Draper, UT (US); Eric Boothe, Provo, UT (US)

(21) Appl. No.: 16/212,291

(22) Filed: Dec. 6, 2018

(51) Int. Cl. H04N 13/327; H04N 13/344; G06T 7/80; H04N 13/167

(52) U.S. Cl. CPC H04N 13/327; H04N 13/344; G06T 7/85; G06K 19/06009; G06T 2207/30204; G06T 2207/20092; H04N 13/167

(57) ABSTRACT

Technology is described to adjust for eye location variations of a user when using an augmented reality (AR) headset. The method can include registering a position and size of an optical code using a visual camera and the AR headset. An alignment marker may be projected through the AR headset to be aligned with the optical code for a right eye and left eye of a user of the AR headset. Right eye and left eye adjustments to the alignment marker may be received independently to align the alignment marker with a portion of the optical code as viewed by either the right eye or left eye of the user. The left eye adjustments and right eye adjustments may be applied to virtual images displayed through the AR headset in order to improve the accuracy of alignment between objects in the physical view and the virtual images displayed using the AR headset.

### BACKGROUND

Mixed or augmented reality is an area of computing technology where images from the physical world and virtual computing worlds may be combined into a mixed reality world. In mixed reality, people, places, and objects from the physical world and virtual worlds become a blended environment. A mixed reality experience may be provided through existing commercial or custom software along with the use of VR (virtual reality) or AR (augmented reality) headsets.

Augmented reality (AR) is an example of mixed reality where a live direct view (e.g. a real-world view through lenses) or an indirect view (e.g., through a camera) of a physical, real-world environment is augmented or supplemented by computer-generated sensory input such as sound, video, graphics or other data. Augmentation is performed as a real-world location is viewed and in context with real environmental elements. With the help of advanced AR technology (e.g. adding computer vision and object recognition) the information about the surrounding real world of the user may become interactive and may be digitally modified.

One issue faced by AR systems or AR headsets is aligning the position of a virtual element with a physical object in a live view of a real-world environment. The alignment resolution of an AR headset may be able to align a virtual object to a physical object being viewed but the alignment resolution may only be aligned to within a few centimeters. Providing alignment to within a few centimeters may be useful for entertainment, games and less demanding applications but greater positioning and alignment resolution for AR systems may be desired in the scientific, engineering, medical and other disciplines desiring greater precision.

### BRIEF DESCRIPTION OF THE DRAWINGS

FIG. 1 is a block diagram illustrating an example of using a graphical marker with an optical code to adjust for variations in a user's eye positions.

FIG. 2 is a diagram illustrating an example of multiple types of graphical markers that may be used for alignment with an optical code to adjust for variations in a user's eye positions.

FIG. 3 is an illustration of a user moving a graphical marker to adjust for a position of a user's individual eyes with respect to an AR headset and a grid pattern for calibration of a camera in an AR headset in an example of the technology.

FIG. 4 is an illustration of an example of aligning a virtual object with a body of a patient after the adjustments for variations in a user's eyes have been determined.

FIG. 5 illustrates an example of an acquired image data set that may be more accurately displayed with respect to a user's eye position after adjustment for variations in a user's eyes have been applied.

FIG. 6 illustrates an example of an acquired image data set that may be displayed using an optical code and image visible maker with respect to a user after adjustments for variations in a user's eyes have been applied.

FIG. 7 illustrates an example of optical codes attached to elastic material that can be moved by breathing of a body of a person.

FIG. 8 is a flowchart illustrating an example of a method to adjust for individual eye location variations to enable improved viewing and/or alignment of virtual objects and visible objects through an augmented reality (AR) headset.

FIG. 9 is a block diagram illustrating an example of a computing system for use with an AR headset or AR display.

FIG. 10 is block diagram illustrating an example of a computing system that may be used with the described technology.

### DETAILED DESCRIPTION

The present technology may provide improved accuracy when using an AR headset or AR system by calibrating the camera optics of an AR headset, calibrating for user characteristics (e.g. individual eye positions), calibrating to and registering to a body of a person being viewed through the AR headset, as well as calibrating for motion of body of a person being viewed. In one configuration, the technology may use optical codes and a graphical marker or a virtual image in an AR (augmented reality) headset to adjust positions of the virtual images an AR (augmented reality) headset projects for viewing by a user, in order to adjust or correct the variances in a user's eye locations and/or an AR headset position on the user's head. For example, anomalies in the eye anatomy of a user (e.g., variances in the location of the eyes from the bridge of the nose, variances in the vertical or horizontal positions of each eye, interpupillary distances, etc.) of the may affect the accuracy of the alignment of virtual elements viewed with real world objects through an AR headset.

In one example, a user can view an optical code (e.g. a real view of an optical code) through an AR headset. The optical code may be a 2D bar code, a QR code, linear bar code, an AprilTag, or another optical code that is visible to cameras or sensors of the AR headset. The AR headset and associated computing system may request that a user align a virtual image with the optical code for each one of the user's individual eyes. The virtual image may be at least one of: a graphical marker, a graphical outline, a wireframe, a virtual optical code, a virtual linear bar code, a virtual 2D bar code, a virtual AprilTag, a virtual object or a geometric outline (e.g., a box or geometric shape). An alignment process may take place for a left eye and then a separate alignment process may take place for the right eye.

The user may use hand gestures to move or drag a graphical marker (e.g., a graphical outline, a virtual optical code or another virtual item) until the graphical marker is aligned with the optical code as viewed from a single eye of the user. Alternatively, the user may use voice commands, eye movements, remote controls (e.g., a finger clicker), a 3D pointer, a VR wand, finger sensors, haptic technology, or other control methods to move the graphical marker. The term alignment, as discussed here, may mean that the graphical marker is either overlapping, adjacent to or nearly adjacent to the optical code being viewed (perfect alignment is not needed to improve alignment). The changes in distance between the aligned position of the graphical marker and the previous position of the graphical marker may be considered delta values that can be recorded for the right eye and left eye separately.

The delta values or changes for the eye position settings for modifying where the virtual images or objects are projected for the individual user can be stored as a user setting or a user profile for each individual user in a user preferences database on the AR headset, in a user's file system on the AR headset (e.g., in flash memory or another mass storage device), in a local or remote server connected to the AR headset, in cloud type storage or in another network accessible location. These eye position modifications may be applied to the virtual objects (e.g., an image data set, a virtual tool, displayed data, etc.) displayed at any angle to the user's eyes through the AR headset. This individual eye modification or correction improves the alignment and the accuracy of the virtual images or virtual objects displayed with physical objects viewed in the real world. The physical objects viewed in the real world may be considered an actual view in the AR headset.

Quantifying the differences in the positions of the user's eyes enable adjustments to provide more accurate alignment of virtual images and real view images as viewed through the AR headset. For example, the IPD (interpupillary distance), the individual positions of the eyes with respect to one another, the position of a user's eyes with respect to a user's head, or the distance between an eye and the bridge of the nose may need to be accounted for to enable more accurate use of the AR headset. In one configuration, the eye position changes or the changes in the projection of the virtual objects (e.g. using one or two delta value sets) may be transformed into an interpupillary distance (IPD) that may be used by the AR headset. A change or correction to the interpupillary distance (IPD) or positions of the user's eyes can be stored on a per user basis in one or more locations, such as, by the AR headset, in a local or remote server or in a cloud type of storage. The IPD can also be provided to an AR headset using the adjustment process described earlier and can be applied to change the locations of virtual images being projected on holographic lenses, waveguides, diffraction gratings or similar optical lenses of the AR headset.

While existing AR headsets may provide correction abilities to adjust for the interpupillary eye distances that vary from one person to another, the adjustments tend to be less accurate and may not provide high precision alignment of virtual images and real-world objects. Simply entering a numeric value to adjust an interpupillary eye distance for a user of an AR headset may not provide a desired level of accuracy or a precise enough level of correction for scientific, medical, military or other precision uses in which the AR headset may be used. In the past, the virtual images or virtual items (e.g., virtual tools, virtual guidance system, overlay images, virtual objects, etc.) generated by an AR headset without adjusting for a user's eye positions on an individual basis may have appeared to be inaccurate or “off” as compared to an expected location of a virtual object with respect to a real-world object.

In another example, where eye positions or the interpupillary distance (IPD) are not accurately calibrated to the user, the rendered virtual images may appear to be at a different scale (e.g., larger or smaller) than real world objects associated with the virtual images. This misalignment can affect the perceived size and/or location of the rendered image. For example, a virtual image or image data set of an Mill (magnetic resonance imaging) scan that is to be aligned with a person's real-world head may appear to be larger than the patient's head on which the image is being overlaid when the position of a user's eyes is not accurate. Furthermore, if the AR headset is askew, tilted, or the headset is misaligned with the user's head, this misalignment may cause the rendered image to appear to be misaligned with a corresponding real-world object. Sometimes the misalignment can be disorienting because the left eye view and right eye view may not appear to match up. For example, storing and using incorrect or inaccurate eye positions for a user of the AR headset may result in separation of the virtual images for the left eye and right eye, which can appear as “double vision” to the user of the AR headset.

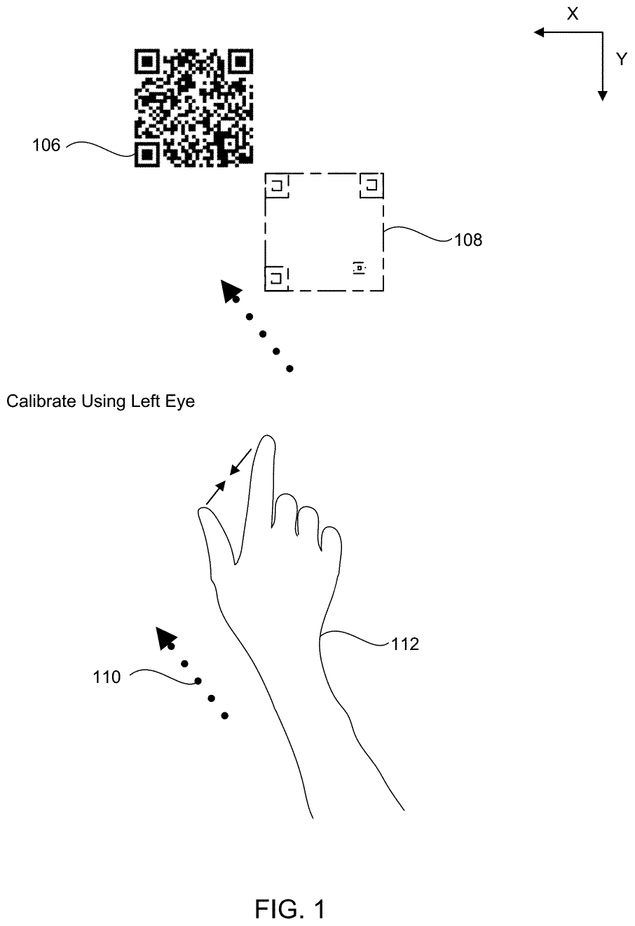

FIG. 1 illustrates a view of a process used for adjusting eye location variations for users when using an augmented reality (AR) headset. The adjustments or corrections may be made on an individual eye basis. Each user's eyes may have a different distance from the bridge of the nose, a different distance from the other eye, a different horizontal position (e.g., in the X axis) and/or a different vertical position (e.g., in the Y axis) with respect to a user's head.

An initial step may register a position and size of an optical code 106 using a visual camera of an AR headset. The size of the optical code may be contained within the optical code itself. For example, a 2D barcode may include encoded information defining the size of the 2D barcode in millimeters, dots per inch, or another measurement. The optical code 106 may be a printed optical code that is on a piece of paper, plastic, glass, etc., and the optical code 106 may be mounted on a vertical surface or another flat surface. For example, the optical code 106 may be placed on a bulletin board, furniture, a window, a table, a floor, machinery or a plastic block. In one configuration, the optical code 106 may be displayed on an LCD screen or another detectable screen.

An alignment marker 108 may be projected onto holographic lenses, waveguides, diffraction gratings or similar optical lenses of the AR headset in order to enable the alignment marker 108 to be aligned with the optical code 106 for a right eye of a user of the AR headset. The AR headset may project the alignment marker 108 in a position using a default interpupillary distance with which the AR headset is programmed. However, due to individual eye location variations, the alignment marker 108 may not actually align with the optical code 106 as viewed by a user through the AR headset. In one configuration, the alignment marker 108 may be initially located at any random offset from the alignment marker 108 (while still using the default IPD).

Right eye adjustments to the alignment marker may be received to align the alignment marker 108 with a portion of the optical code 106 as viewed by the right eye of the user. The right eye adjustments may be provided to the AR headset using a hand gesture 112. For example, pinching the fingers may select or “grab” the alignment marker 108 and then moving the user's arm 112 may move the alignment marker 108. Releasing the fingers may release the alignment marker 108. The distance 110 traveled by the alignment marker when being moved, dragged or pushed across the AR headset's view may be considered the right eye adjustments or corrections. These adjustments may be change values or delta values measured in metric units, Imperial units, pixels, light points (e.g., in the Microsoft Hololens environment) or other measurement units. In one configuration, the user may select the alignment marker 108 and then point to the location where the user wants the alignment marker 108 to move.

A similar process may be repeated for the left eye. The alignment marker 108 may also be projected in the AR headset to be aligned with the optical code 106 for a left eye of the user of the AR headset. Using the process described earlier (e.g., selecting, dragging, pointing, pushing, etc.), left eye adjustments to the alignment marker 108 may be received to align the alignment marker 108 with a portion of the optical code 106 for the left eye of the user. Once the adjustments have been received, they may be stored in a non-volatile memory of the AR headset, in a local or remote server, or in a cloud type of storage for each user of the headset. As explained, measurements that a user reports provide good alignment for each eye may be taken independently. The eye not being aligned may be covered with a card or closed to obtain an adjustment for the eye being aligned.

The left eye adjustments and right eye adjustments may be applied to adjust the location of the virtual images displayed through the AR headset. The adjustments may be applied to improve the accuracy of alignment between the virtual images or virtual objects displayed and the physical view. More specifically, a position of the projected images projected on the holographic lenses, waveguides, diffraction gratings or other optical lenses of the AR headset may be adjusted using an updated interpupillary distance which is updated with the right eye and left eye adjustments. The AR headset may project virtual objects on the holographic lenses, waveguides, diffraction gratings, or similar optical structures of the AR headset based on the revised interpupillary distance between the eyes. The position of the user's eyes may be considered a virtual camera viewpoint for the virtual objects rendered and displayed for each separate eye. Adjusting the user's eye position adjusts the virtual camera viewpoint used for rendering virtual objects or graphical objects that are projected in the AR headset for each eye.

The eye adjustments may be transformed into an interpupillary distance (IPD) between the right eye and left eye of a user by computing and then modifying a stored interpupillary distance containing the right eye adjustments and left eye adjustments. The updated interpupillary distance (IPD) may then be applied as the eye adjustment in the AR headset. The virtual objects may be projected onto holographic lenses, waveguides diffraction gratings, or similar optical materials of the AR headset using the revised interpupillary distance (IPD). The revised interpupillary distance (IPD) for a distance between the eyes of the user may be stored in a user profile for each individual user of the AR headset. Alternatively, the right eye adjustments and the left eye adjustments may be stored in a user profile as a specific eye position for each eye (e.g., X and Y delta values).

The graphical marker may be a graphical outline or wireframe for the optical code. For example, the wireframe may be an outline of the optical code and/or any features of interest in the optical code such as boxes, reference points or other recognizable features in the optical code. As discussed before, the optical code may a QR code, a 2D bar code, linear bar code, one or more AprilTags, or other optical codes. The right eye adjustments and left eye adjustments may be created by referencing an adjustment to a position of the wireframe in two axes for both the right eye and left eye of the user. More specifically, adjustments may be recorded in an X and Y axis as provided by the user of the AR headset. The adjustments may be absolute coordinates in a reference system of the AR headset, or the adjustments may be relative adjustments from an expected aligned position of the graphical marker with respect to the optical code.

The right eye adjustments and left eye adjustments may be used to compensate for a user's eye variations. For example, the corrections or delta values may be used to correct variations where a distance from the bridge of the nose to each of the user's eyes is not the same or corrections may be made for asymmetries in the user's vertical or horizontal position of one eye or both eyes. Similarly, the right eye adjustments and left eye adjustments may be used to compensate for positioning of the AR headset on the user's head.

In another configuration of this technology, the AR headset or AR system may provide feedback to the user to adjust the AR headset to enable better alignment of the user's eyes with the virtual images projected by the AR headset. For example, after making the right and left eye adjustment, the AR headset may determine that the user should first move the AR headset so that the user's eyes may be better calibrated. In other words, the AR headset may be so far off that it should be re-seated on the user's head. For example, a message may be displayed to the user though the AR headset that the user should tilt the headset forward, backward, to the left side or to the right side a certain measurement to assist with correcting the calibration for the user's eyes. More specifically, the AR headset may ask the user to tilt the AR headset on the user's head forward 3 centimeters. Moving the position of the AR headset will move the position of the cameras or sensors of the AR headset and assist with calibration. At this point, the eye calibration may be performed again. The user may be asked to move the AR headset again or the AR headset may determine that further eye calibrations can be made by adjusting the virtual images using the calibration method as described earlier.

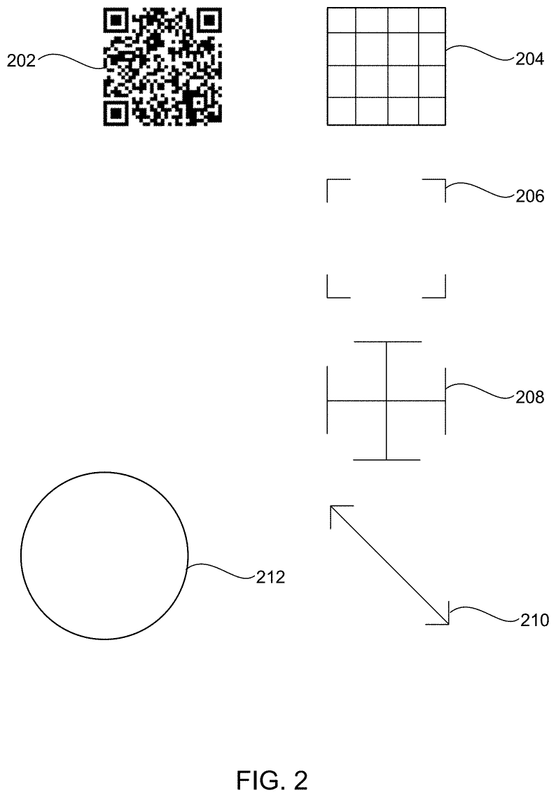

FIG. 2 illustrates multiple types of graphical markers that may be used to correct for the actual eye position of a user by using an optical code 202. Any number of different types of graphical markers 204-210 may be aligned with the optical code 202. One example of a graphical marker may be a simple grid 204. Other examples of graphical markers may be the squared corners of a square 206, a target type of graphical marker 208 or two opposite corners 210. A circular graphical marker 212 may be used to circumscribe and touch the corners of the optical code 202. Alternatively, a single 90-degree corner graphical marker may be used for alignment. Any graphical marker may be used which provides alignable marking points to enable a user to align the graphical marker with the optical code 202 in at least two dimensions (e.g., the X and Y dimensions).

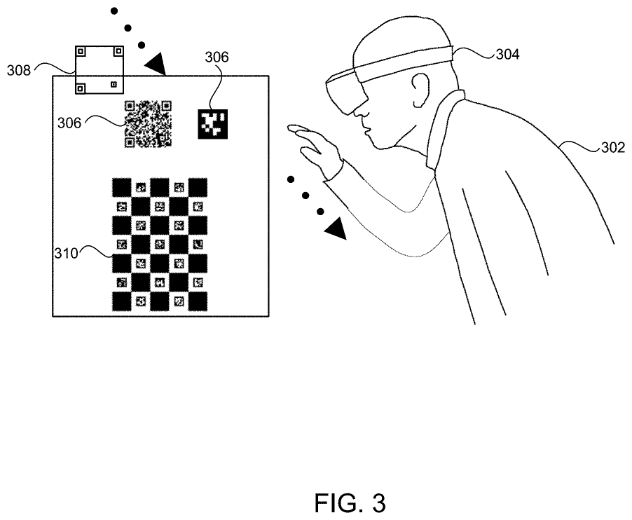

FIG. 3 illustrates a user 302 that is wearing an AR headset 304 and viewing an optical code 306 that is placed on a wall or displayed on another flat surface (e.g., vertical or horizontal) in the user's surroundings. The calibration may be performed by locating a QR Code and rendering a graphical marker or wireframe outlines sized to match the QR Code. In addition, the AR headset 304 may project a graphical marker 308 that may be viewed by the user 302 through the AR headset 304.

The user 302 may select and drag the graphical marker 308 using a hand gesture until the graphical marker 308 aligns with the optical code 306. More specifically, the user can then independently modify the alignment for each eye (e.g., left and right) in order to line up the rendered outline with the real world QR Code. A change in the distance to create the alignment may be recorded and this change can be used to adjust where virtual objects are projected by the AR headset. The calibration may adjust or correct the user's interpupillary distance (IPD) and may compensate for other cases where there are asymmetries in the user's vertical or horizontal eye position, as well as the positioning of the device on the user's head. Not only is the interpupillary distance different for each individual, the distance between the bridge of the nose and each pupil may vary between individuals and may reduce the accuracy of the virtual image projected within the AR headset. Because the calibration compensates for these possible eye and headset issues, the calibration makes the virtual and real-world objects align more exactly when viewed through the AR headset.

To reiterate and summarize, this technology enables calibration of a user's individual eye positions using a printed optical code that the AR headset detects and then computes the 3D position of the optical code. The graphical marker or virtual representation of the code can then be displayed for the left and right eye in proximity to the physical optical code. The user may then adjust each individual eye view-position to match their actual eye position so that the patterns line up accurately.

FIG. 3 further illustrates that to use optical codes for determining the position of objects in 3D space, an accurate calibration of the camera lens used for registering the optical codes and objects can be useful. A visual camera or another sensor on the AR headset can be used to capture images and register the optical tags (e.g., AR tags). To perform accurate and improved precision registration and alignment using the optical code, the camera properties or camera calibration properties can be calibrated and the camera properties may include: a focal length of the lens, a focal center of the lens, radial distortion properties of the camera, tangential distortion properties of the camera, or other camera properties.

While a camera manufacturer may provide initial values for such properties, the actual values of camera properties being used in a given AR headset may differ due to manufacturing variations, install variations or other anomalies. The camera properties may even change over time or with temperature changes. Accordingly, a camera calibration operation may be performed to compute those properties more accurately for the camera that is actually being used. The calibration may be done with a printed chess-board like grid pattern and black squares. In addition, the calibration can be done with a printed grid 310 of just optical tags (e.g., AprilTags). Once the printed grid has been captured, functions can be applied to detect the existing distortion in the printed grid. Corrections for these distortions may be calculated and used to calibrate the camera (i.e., the images returned from the camera).

FIG. 3 illustrates that a calibration page may be printed with a grid pattern on the page along with the optical code to calibrate the camera. For example, a grid pattern of AprilTags 310 may be displayed with a QR code 306 above the AprilTags. The camera calibration step computes the camera properties from the visual grid and does not require user input. However, user input may start the camera calibration. Having both calibration patterns on one page can be efficient for a user who is calibrating the AR headset. In another example, there may be a QR code at a center point of a page with AprilTags around the QR code.

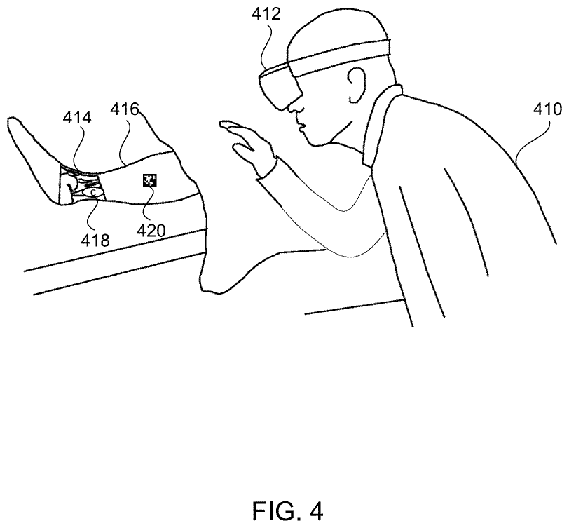

FIG. 4 illustrates an example use of calibrated virtual images where a doctor or medical professional 410 may be using an AR headset 412. While medical examples may be shown herein, the present technology may be used for other high precision disciplines, such as medicine, engineering, manufacturing, and other similar disciplines. After the calibration described previously has been completed, then virtual objects may be aligned with real-world objects more accurately. In one example the AR headset 412 may enable a medical professional to see through holographic lenses, waveguides, diffraction gratings or other optical lenses where an augmented reality image or acquired medical image is projected on the semi-transparent holographic lenses. As a more specific example, an MRI (magnetic resonance image) image data set may be overlaid in an area where an operation is going to occur. The overlaid image results in a compositing of views with a real-world scene.

A medical doctor or other medical professionals may set up an AR headset 412 in a surgery area or surgical theater. A processor associated with the AR headset 412 may receive a visual image of real-world patient anatomy 416 using a visual image camera or sensor in the AR headset 412. An acquired medical image 414 associated with the patient anatomy can then be retrieved. This acquired medical image may be an MRI or CT (computed tomography) image that is fed via a wireless connection to the processors and memory in the AR headset.

The acquired medical image 414 can then be associated with or anchored to the patient anatomy 416 that has been identified by the AR headset 412 in the real-world scene or space. The anchoring may include fixing or anchoring the acquired medical image or other related virtual images (including augmentation controls) to a fixed point in the viewable real world that has been registered by the AR headset 412. An example of a fixed point may be an optical code 420 and an image visible marker attached to the optical code 420, as described at a later point in this document. Then when a medical professional moves view point positions, the acquired medical image 414 may remain fixed in the correct spot with respect to the patient's anatomy and does not move around in the doctor's vision. In some cases, a new image projection from the acquired medical image 414 or 3D image data set may be generated when the medical professional moves and the medical professional may see changing views of the acquired medical image 414 as the medical professional moves around the patient.

An augmentation tag 418 associated with a location in one layer of the acquired medical image 414 or radiological image can also be retrieved from a data store. The augmentation tag 418 may be configured to conform to a three-dimensional (3D) structure in the acquired medical image 414 or radiological image to identify an anatomical structure associated with a medical procedure to be performed. The augmentation tag may be a simple geometric shape such as a circle, square, triangle or another more complex shape in two dimensions or three dimensions, such as an outline of the anatomy in question. It is valuable when the augmentation tag 418 is located in the correct location and the alignment technology of the present technology assists with properly aligning the augmentation tag 418 with the correct real-world anatomical structure.

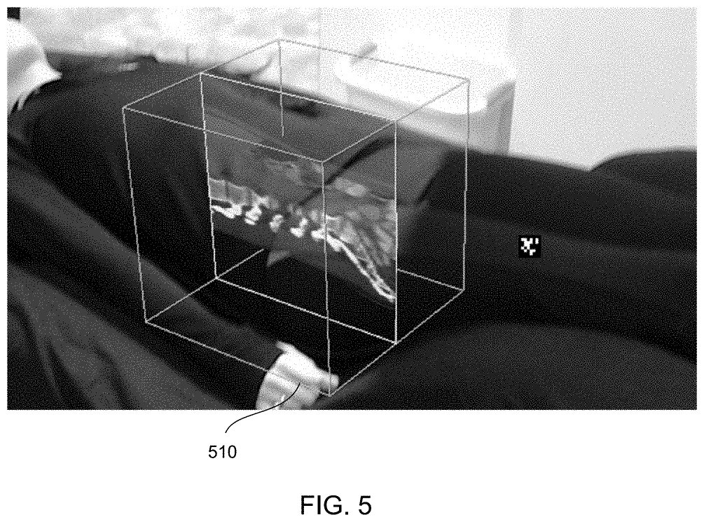

FIG. 5 illustrates an acquired medical image 510 that is aligned with a body of patient. Where a correction has been made for the user's eye positions, then the acquired medical image may be more accurate in location and size with respect to the view of the real patient. In addition, image separation or double vision for users who may have anomalies in their eye positions are less likely to occur.

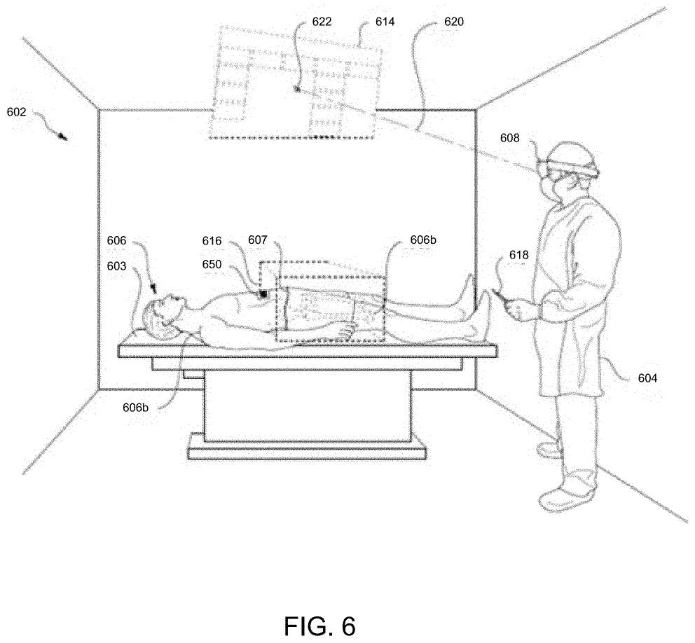

FIG. 6 illustrates an example augmented reality (AR) environment in which adjustments or corrections for eye alignment may result in more accurate results when displaying virtual images an AR headset. FIG. 6 illustrates that an image data set 616 of a patient or person may be aligned with actual views of the patient 606 using an optical code 650 affixed to the patient 606. The environment may include a physical space 602 (e.g., operating theater, a lab, etc.), a user 604, an operating table 603, the patient 606, fabric covering the patient 607, one or more optical codes 650 on the patient 606, a medical implement 618 with an optical code, and an AR headset 608 in communication with a server over a computer network. A virtual user interface 614 and a virtual cursor 622 are also shown in dashed lines to indicate that these virtual elements are generated by the AR headset 608 and are viewable 622 by the user 604 in the user's field of vision 620 through the AR headset 608. The U.S. utility patent application entitled “USING OPTICAL CODES WITH AUGMENTED REALITY DISPLAY” filed on Nov. 17, 2018 having Ser. No. 16/194,333 is incorporated by reference herein.

The AR headset 608 may be an AR computing system that is capable of augmenting actual views of the patient 606 with an image data set 616. For example, the AR headset 608 may be employed by the user 604 in order to augment actual views of the patient 606 with one or more 3D image data set views or radiological images 616 of the patient 606 including, but not limited to, displays of bones 606b, muscles, organs, or fluids. The AR headset 608 may allow a projection of the image data set to be dynamically reconstructed. So, as the user 604 moves around the patient 606, the sensors of the AR headset 608 may determine the location of the user 604 relative to the patient 606, and the internal anatomy of the patient displayed using the image data set can be reconstructed dynamically as the user chooses different orientations relative to the patient. For example, the user 604 may walk around the patient 606. Then the AR headset 608 may augment actual views of the patient 606 with one or more acquired radiology images or image data sets (MRI, CT scan, etc.) of the patient 606, so that both the patient 606 and the image data set of the patient 606 may be viewed by the user 604 from any angle (e.g., a projected image or a slice from the image data set may also be displayed). The AR headset 608 may be a modified version of the Microsoft HOLOLENS, Meta Company META 2, Epson MOVERIO, Garmin VARIA VISION or other AR headsets.

The one or more optical codes 650 may be affixed to the patient 606 prior to the generation of image data of the patient 606 (e.g., capture of the Mill, CT scan, X-ray, etc.), and then remain affixed to the patient 606 while the patient 606 is being viewed by the user 604 through the AR headset 608. Then, the optical code 650 and an image visible marker may be employed by the AR headset 608 to automatically align the image data set 616 of the patient with actual views of the patient 606.

The optical code 650 may further be associated with image visible codes or an image visible marker (not shown in FIG. 6) that are perceptible to a non-optical imaging modality (e.g., Mill, CT, etc.). Forming the image visible codes or markers from a material, which is perceptible to a non-optical imaging modality, may enable the image visible markers to appear in an image data set of the patient 606 that is captured using a non-optical imaging modality. Examples of image visible codes or markers include, but are not limited to: metal spheres, liquid spheres, radiopaque plastic, metal impregnated rubber, metal strips, paramagnetic material, and sections of metallic ink. The image visible markers may be arranged in a pattern and may have a fixed position relative to a position of the optical code 650. By arranging the markers in a pattern that has a fixed position relative to a position of the optical code 650, this fixed position may be employed to calculate the location of the pattern of the markers or image visible markers with respect to a visible location of the optical code 650, even where the markers are not themselves visible or perceptible to sensors of the AR headset 608.

After detecting the optical code 650 in the 3D space 602, the AR headset 608 may automatically calculate the position of the pattern of the image visible codes in the 3D space 602 and with respect to one another. This automatic calculation may be based on the sensed position of the optical code 650 in the 3D space 602 and may also be based on the known fixed position of the pattern of the image visible codes relative to the position of the optical code 650. Even where the image visible codes are not perceptible to the AR headset 608 (for example, due to the image visible codes being embedded or underneath a material), the AR headset 608 can automatically calculate the location of the pattern of the image visible codes based on the position of the optical code 650 and on the fixed position of the pattern of the image visible codes relative to the position of the optical code 650. In this example, these fixed positions may enable the AR headset 608 to automatically calculate the position of the pattern of the image visible codes in the 3D space 602 with respect to one another even where the AR headset 608 is not directly sensing the positions of the image visible codes.

After calculating the location of the pattern of the image visible markers in the 3D space 602, the AR headset 608 may then register the position of the internal anatomy of the patient 606 in the 3D space 602 by aligning the calculated position of the pattern of the image visible codes in the 3D space 602 with the position of the pattern of the virtual image visible codes in the image data set. The alignment may be performed based on the calculated position of the pattern of the image visible codes in the 3D space 602 and the fixed position of the image data set to the image visible codes relative to the positions of the internal anatomy of the patient 606. This alignment and registration may then enable the AR headset 608 to display in real-time the internal anatomy of the patient 606 from the image data projected onto actual views of the patient 606.

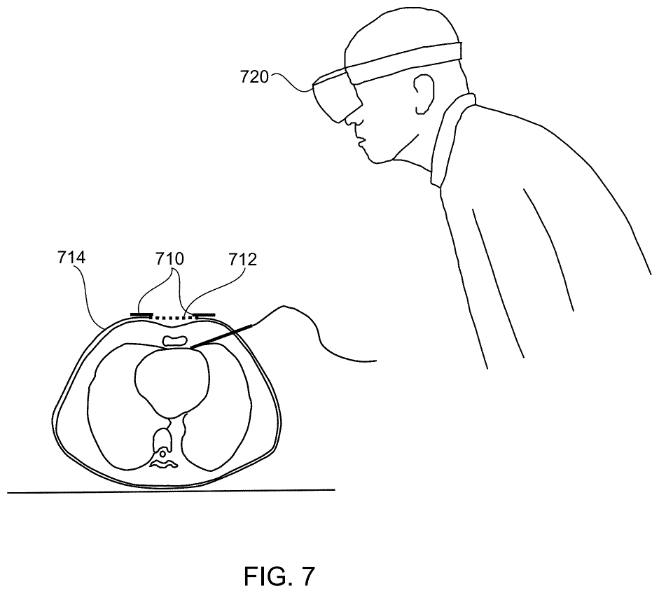

FIG. 7 illustrates an example of using an optical code to enhance the accuracy of virtual images displayed in an AR headset by calibrating for motion of body of a person being viewed, such as during breathing of a patient. One or more optical codes 710 may be affixed to a piece of elastic material 712 or another material that can stretch and return to an original shape. This elastic material 712 may be a bandage type of material or another type of stretchy fabric (e.g. elastic material, elastic fabric, etc.). The optical codes 710 may be attached at a fixed and known distance from one another. During a time frame where a person breathes in and out, the distance between the optical codes can change. When a patient inhales, the distance between the optical codes can increase and when a patient exhales, the distance between the optical codes can decrease as the elastic material returns to the original position. The elastic material 712 may be used to draw or pull the optical codes back together when the patient exhales to the original position of the optical codes.

In one configuration a belt may be attached to the elastic material 714 and the elastic material 712 may join two ends of the belt. The belt may encircle the patient around an area of the torso and hold the elastic material 712 and the optical codes in place. Alternatively, the elastic material may be attached to or affixed to the skin of the patient and the optical codes 710 can be glued or attached onto the elastic material.

The position and/or orientation of the optical codes 710 may be detected or registered using an AR headset 720. The distance between the optical codes may be calculated by the AR headset 720 as the distance changes over time during a patient's breathing cycle. This detected distance may be used to determine a change in position of the patient's organs (e.g., kidneys, liver, lungs, etc.) or other internal structures while the patent is breathing. An acquired 4D image data set that corresponds to a portion of the patient's body upon which a procedure is to be performed may be aligned with the patient's body, using methods described earlier. This acquired image data set may be a 4D image data set that includes many 3D image data sets over a time period (4D) and the 4D image data set may represent the change in positions of the patient's internal structures as the patient is breathing.

The 4D image data may be aligned with the patient's body in the correct spatial location as discussed earlier and the 4D image data sets may also be synchronized with the patient's breathing over the breathing time period. Alternatively, the 4D image data may be aligned the body of the person by aligning the acquired image data set with a surface contour of the body of the person or by performing manual alignment of the acquired image data set with the body of the person. This may provide an animated view of the patient's internal organs as the patient is breathing. For example, an acquired 3D image set where a patient has completely exhaled may be aligned with the patient spatially and temporally when the patient has actually exhaled completely, as viewed through the AR headset. A similar spatial and temporal alignment can occur when the patient has completely inhaled. The acquired images may be aligned for each portion of the breathing cycle. This spatial and temporal alignment allows a medical professional to perform medical procedures more accurately. For example, if a medical implement, such as needle or trocar, needs to be inserted with respect to a specific organ and that organ is moving during breathing, the aligned 4D image data set can illustrate to the medical professional where to more accurately insert the medical implement into the patient's body at any point during the breathing cycle of the patient.

A method for spatially and temporally aligning acquired image data sets with a body of a user during breathing is also provided. One or more optical codes may be registered, through an AR headset, which are attached to an elastic material configured expand and contract when moved by a body of a person breathing. Distances of a first optical code from a second optical code may be used to measure breathing of a patient over time. A time period for a breathing cycle of the patient may be detected using a maximum and minimum distance between the first and second optical codes. A third optical code may also be attached to the body of the person. Acquired image data sets with a virtual image visible marker may be aligned with the body of the person using the third optical code on the body of the person and an image visible marker attached to the third optical code that is aligned with a virtual image visible marker in the acquired image data sets. The acquired image data sets may be displayed in temporal alignment with the time period for a breathing cycle of the patient based in part on the detected distances between the first optical code and the second optical code over time. Thus, each of the 3D image data sets will be displayed at points in the breathing cycle where the internal tissue positions for the body of the person matches the 3D image data set that was previously acquired for that same point in the breathing cycle.

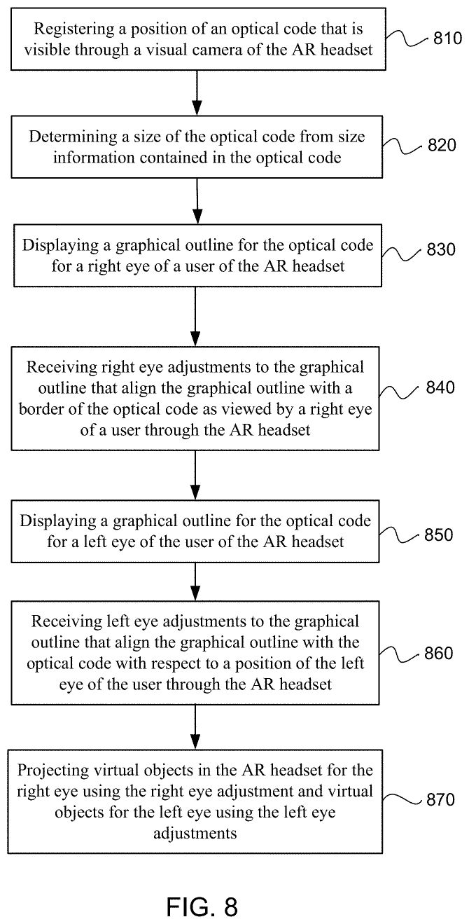

FIG. 8 illustrates an example method to adjust for individual eye location variations and to enable improved alignment of virtual objects and visible objects viewed through an augmented reality (AR) headset. The method may include the function of registering a position of an optical code that is visible using a visual camera of the AR headset, as in block 810. This may include locating and scanning a QR Code. The position of the optical code as viewed by the AR headset may be determined in X and Y coordinates or other coordinates as viewed through the AR headset.

Another function may be determining a physical size of the optical code from size information encoded into or contained in the optical code, as in block 820. The size information may represent a real-world size or real-world measurement that is known in advance. The size may be encoded directly into the optical code and may provide the size of the optical code in a measurement system, such as metric units, Imperial units, dots per inch printed, pixels in a sensor, light points, etc.

A graphical outline for the optical code for a right eye of a user of the AR headset may be rendered and displayed, as in block 830. Using the measurement data received from the optical code, graphical outlines may be rendered to be located near the squares of the corners of the QR Code or other graphical outlines may be generated using the size of the optical code.

Another function may be receiving right eye adjustments to the graphical outline that align the graphical outline with a border of the optical code, as viewed by a right eye of a user through the AR headset, as in block 840. The user may move the graphical outline for each eye independently and the user input movements of the graphical outline may be recorded. In one configuration, the user may close the user's eye, or a card or cover may be inserted between the user's eye and the AR headset to cover the user's eye during the adjustment function for an eye.

The graphical outline for the optical code for a left eye of the user of the AR headset may then be rendered and displayed, as in block 850. Left eye adjustments to the graphical outline may be received that align the graphical outline with the optical code based on a position of the left eye of the user as seen through the AR headset, as in block 860. The eye adjustments may be measured using a distance traveled by the graphical outline until alignment is reached as defined by hand movements, 3D pointer movements, mouse movements or other movements that result in dragging, moving, or otherwise re-situating the graphical outline.

A further function may be projecting virtual objects in the AR headset for the right eye using the right eye adjustment and virtual objects for the left eye using the left eye adjustments, as in block 870. In other words, the adjustments gathered using the graphical outline or graphical marker may then be continuously applied to rendered images viewed through the AR headset in order to improve the alignment between the physical objects and virtual images. The adjustments to the images may be applied separately for the left eye and right eye. In addition, the adjustments for each eye may be different because individuals separate eyes may each have separate locations (are not symmetric) with respect to their head or nose.

The method of correcting for variations of an individual eye location for a user may be applied for a single eye. Correcting for variations in a position of a single eye may be used where one of the eyes is already in alignment due to a good physiological alignment or a previous alignment process applied to one of the eyes. Alternatively, the placement of the AR headset may result in good alignment of one eye and not another. Thus, alignment for just one eye may be performed.

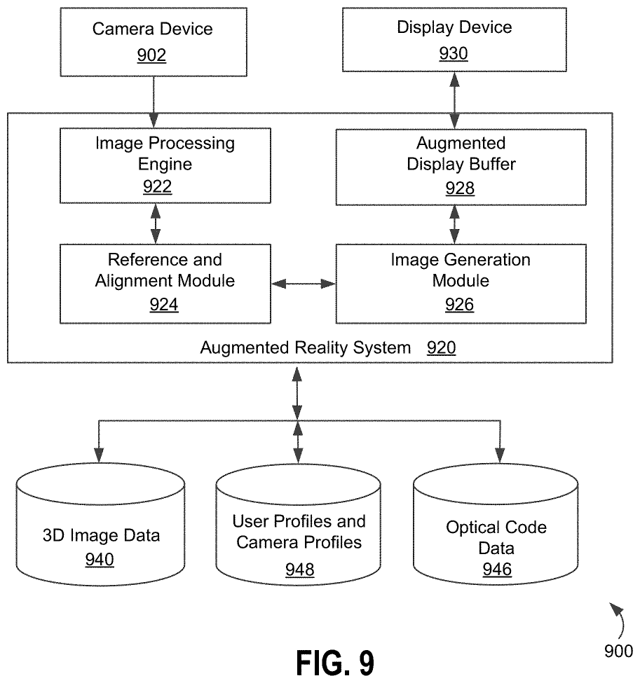

FIG. 9 illustrates an example system that may be employed to adjust for eye location variations when using an augmented reality (AR) headset. The eye adjustments may be used to align virtual images with real world objects viewed through the AR headset. The system 900 may include a camera device 902, an augmented reality system 920, a display device 930, and a plurality of databases. The system 900 may also include one or more processors, a memory, a file system, a communication unit, an operating system, and a user interface, which may be communicatively coupled together. In some embodiments, the system 900 may be, for example, a desktop computer, a server computer, a laptop computer, a mobile device, a tablet computer, an embedded computer, an AR headset, a VR headset, or some combination of these systems, etc.

The camera device 902 can be configured to capture visible data. In one example, the camera device 902 may be used to capture visible data. The camera device 902 may transmit the optical data to the augmented reality system 920. The system also may include depth sensors, surface sensors, optical sensors, infrared sensors, Lidar sensors or other sensors to detect and assist with mapping a real view or actual view detected by the AR system. Any object or surface may be detected including boundaries of a room, a person, furniture, physical geometry, tools, or any other physical surroundings or objects. The AR system may align virtual objects with real world objects that are detected.

The augmented reality system 920 may include an image processing engine 922, a reference and alignment module 924, an image generation module 926, and an augmented display buffer 928. For example, the image processing engine 922 receives the captured visible image data from the camera device 902 and analyzes the visible image data to identify one or more optical codes, objects or people in the visible image data. A plurality of different techniques may be used to identify optical codes, objects or people within the visible image data including but not limited to feature extraction, segmentation, and/or object detection.

The image processing engine 922 may also identify optical codes that may be affixed to a wall, a card, or a person within the visible image data. Once the image processing engine 922 identifies an optical code (e.g., an AprilTag, a bar code, a QR code, etc.) then real-world size information may be obtained from the optical code.

The reference and alignment module 924 may engage with the image processing engine 922 to receive adjustments made to the graphical marker and to align the graphical marker with the optical code. Once adjustments have been received for a user's eyes, the reference and alignment controller 924 can align virtual objects with real world objects. In one example, virtual images, virtual objects, or acquired image data sets may be aligned with real world objects such as patients, machinery, buildings, scientific equipment or other objects.

The image generation module 926 can generate a graphical marker that can be aligned to the optical code as discussed earlier. In addition, the image generation module 926 may provide graphical objects, virtual tools, medical imaging, or medical guidance to display in a display device 930 to be layered on top of or associated with real world or real view objects seen through the AR headset. In one configuration, this graphical information can be loaded into an augmented display buffer 928. This information can then be transmitted to a display device 930 for display to a user.

3D image data of modeled objects, acquired 3D images, 3D data sets (e.g., geographic data, medical data, scientific data, etc.) may be stored in the 3D image data 940. In some examples, the 3D image data may be aligned with other real world or real view objects. Data related to optical codes may be contained in an optical code database 946. For example, data identifying a physical object that has an optical code on the physical object may be stored in the database. A user profiles data store and camera profiles data store 948 may be used to store the user profiles containing the left eye and right eye adjustments or the interpupillary adjustments, as described earlier. These user profiles may be stored on a per user basis. For example, each medical professional that uses the AR headset may have a separate user profile. In addition, camera profiles or calibrated camera properties may be stored in the user profiles and camera profiles data store 948. The user profiles and camera profiles data store 948 may be part of the AR system 920, stored on a local or remote server, or stored in a cloud type of computing service.

In some embodiments, the augmented reality system may be located on a server and may be any computer system capable of functioning in connection with an AR headset or display device 930. The server may be configured to communicate via a computer network with the AR headset in order to convey image data to, or receive data from, the AR headset.

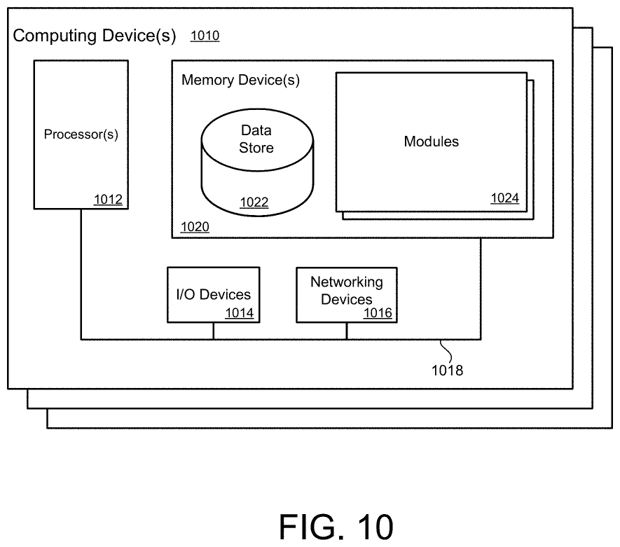

FIG. 10 illustrates a computing device 1010 on which modules of this technology may execute. A computing device 1010 is illustrated on which a high level example of the technology may be executed. The computing device 1010 may include one or more processors 1012 that are in communication with memory devices 1020. The computing device may include a local communication interface 1018 for the components in the computing device. For example, the local communication interface may be a local data bus and/or any related address or control busses as may be desired.

The memory device 1020 may contain modules 1024 that are executable by the processor(s) 1012 and data for the modules 1024. The modules 1024 may execute the functions described earlier. A data store 1022 may also be located in the memory device 1020 for storing data related to the modules 1024 and other applications along with an operating system that is executable by the processor(s) 1012.

Other applications may also be stored in the memory device 1020 and may be executable by the processor(s) 1012. Components or modules discussed in this description that may be implemented in the form of software using high level programming languages that are compiled, interpreted or executed using a hybrid of the methods.

The computing device may also have access to I/O (input/output) devices 1014 that are usable by the computing devices. An example of an I/O device is a display screen that is available to display output from the computing devices. Other known I/O device may be used with the computing device as desired. Networking devices 1016 and similar communication devices may be included in the computing device. The networking devices 1016 may be wired or wireless networking devices that connect to the internet, a LAN, WAN, or other computing network.

The components or modules that are shown as being stored in the memory device 1020 may be executed by the processor 1012. The term “executable” may mean a program file that is in a form that may be executed by a processor 1012. For example, a program in a higher level language may be compiled into machine code in a format that may be loaded into a random access portion of the memory device 1020 and executed by the processor 1012, or source code may be loaded by another executable program and interpreted to generate instructions in a random access portion of the memory to be executed by a processor. The executable program may be stored in any portion or component of the memory device 1020. For example, the memory device 1020 may be random access memory (RAM), read only memory (ROM), flash memory, a solid state drive, memory card, a hard drive, optical disk, floppy disk, magnetic tape, or any other memory components.

The processor 1012 may represent multiple processors and the memory 1020 may represent multiple memory units that operate in parallel to the processing circuits. This may provide parallel processing channels for the processes and data in the system. The local interface 1018 may be used as a network to facilitate communication between any of the multiple processors and multiple memories. The local interface 1018 may use additional systems designed for coordinating communication such as load balancing, bulk data transfer, and similar systems.

Reference has been made to the examples illustrated in the drawings, and specific language has been used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure, are to be considered within the scope of the description.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

The technology described here can also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which can be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

1. A method to adjust for eye location variations of a user of an augmented reality (AR) headset, comprising:
registering a position and size of an optical code using a visual camera and the AR headset;
displaying an alignment marker, through the AR headset, to be aligned with the optical code for a right eye of a user of the AR headset;
receiving right eye adjustments to the alignment marker that align the alignment marker with a portion of the optical code as viewed by the right eye of the user;
receiving left eye adjustments to the alignment marker that align the alignment marker with a portion of the optical code as viewed by a left eye of the user; and
applying left eye adjustments and right eye adjustments to virtual images displayed through the AR headset in order to improve an accuracy of alignment between physical objects in a physical view and the virtual images displayed using the AR headset.

2. The method as in claim 1, further comprising:
computing an interpupillary distance between the right eye and left eye of a user by using the right eye adjustments and left eye adjustments; and
applying the interpupillary distance as an alignment adjustment for the virtual images.

3. The method as in claim 2, further comprising adjusting a position of projected virtual images on holographic lenses or waveguides of the AR headset using the interpupillary distance.

4. The method as in claim 1, further comprising storing the right eye adjustments and the left eye adjustments in a user profile on a per user basis.

5. The method as in claim 2, further comprising storing the interpupillary distance between eyes of the user in a user profile.

6. The method as in claim 1, wherein the right eye adjustments and left eye adjustments include an adjustment to a position of an alignment marker that is a wireframe image in two axes for the right eye and left eye of the user.

7. The method as in claim 1, wherein the alignment marker is a wireframe including an outline that is a size of a perimeter of the optical code.

8. The method as in claim 1, further comprising using the right eye adjustments and left eye adjustments to compensate for a user's eye variations where a correction is for at least one of: a distance from a bridge of a nose to each of the user's eyes or asymmetries in the user's vertical or horizontal position an eye.

9. The method as in claim 1, further comprising using the right eye adjustments and left eye adjustments to compensate for positioning of the AR headset on the user's head.

10. The method as in claim 1, further comprising calibrating to align virtual images and real-world objects more accurately for a user's actual eye positions with respect each other and the user's head.

11. The method as in claim 1, wherein the optical code is at least one of: an AprilTag, a QR code, a 2D bar code, or a linear bar code.

12. The method as in claim 1, wherein the optical code includes data representing a measurement of the optical code's size.

13. The method as in claim 1, wherein the alignment marker is a graphical outline that is displayed as squared corners to match corners of the optical code.

14. The method as in claim 1, further comprising enabling the user to adjust a position and orientation of the alignment marker for each eye independently.

15. The method as in claim 1, further comprising calibrating a camera of the AR headset using a grid pattern, wherein a focal length of a lens, a focal center of a lens, radial distortion properties of the camera and tangential distortion properties of the camera are calibrated.

16. A method to adjust for individual eye location variations when viewing virtual objects and visible objects aligned through an augmented reality (AR) headset, comprising:
registering a position of an optical code that is visible through a visual camera of the AR headset;
determining a size of the optical code from size information contained in the optical code;
displaying a graphical outline for the optical code for a right eye of a user of the AR headset;
receiving right eye adjustments to the graphical outline that align the graphical outline with a border of the optical code as viewed by a right eye of a user through the AR headset;
receiving left eye adjustments to the graphical outline that align the graphical outline with the optical code with respect to a position of the left eye of the user through the AR headset;
storing the right eye adjustments and the left eye adjustments in a user profile for each individual user of the AR headset; and
projecting virtual objects in the AR headset for the right eye using the right eye adjustment and virtual objects for the left eye using the left eye adjustments.

17. The method as in claim 16, further comprising computing an interpupillary distance between the right eye and left eye of a user by using the right eye adjustments and left eye adjustments.

18. The method as in claim 17, further comprising adjusting virtual objects projected onto a holographic lens or a waveguide of the AR headset using the interpupillary distance.

19. A method of correcting for individual eye location variations for a user to enable virtual objects to be aligned with real objects as displayed through an augmented reality (AR) headset, comprising:
registering a position and size of an optical code that is visible using a visual camera of the AR headset;
displaying an alignment marker, projected in the AR headset, to be aligned with the optical code with respect to an eye of a user;
receiving eye adjustments to the alignment marker that align the alignment marker with a portion of the optical code as viewed by the eye of the user; and
applying the eye adjustments to virtual images displayed in the AR headset in order to improve accuracy of alignment between physical objects in an actual view and virtual images displayed using the AR headset.

20. The method as in claim 19, wherein the optical code includes data representing a measurement of a physical size of the optical code.

21. A method of calibrating an augmented reality (AR) headset, comprising:
calibrating a camera of the AR headset using a grid pattern;
registering a position and size of an optical code using a visual camera and the AR headset;
displaying an alignment marker, through the AR headset, to be aligned with the optical code for a right eye of a user of the AR headset;
receiving right eye adjustments to the alignment marker that align the alignment marker with a portion of the optical code as viewed by the right eye of the user;
receiving left eye adjustments to the alignment marker that align the alignment marker with a portion of the optical code as viewed by a left eye of the user; and
applying left eye adjustments and right eye adjustments to virtual images displayed through the AR headset in order to improve an accuracy of alignment between physical objects in a physical view and the virtual images displayed using the AR headset.

22. A method as in claim 21, wherein a calibration property to be adjusted for a camera is selected from at least one of a focal length of a lens, a focal center of a lens, radial distortion properties of the camera or tangential distortion properties of the camera are calibrated.

23. The method as in claim 22, further comprising storing calibration properties of the camera for the AR headset.

24. The method as in claim 21, further comprising storing the left eye and right adjustments to a user calibration file of an individual user.

25. A method for temporally aligning acquired image data sets with a body of a user during respiration, comprising;
registering one or more optical codes, through an AR headset, which are attached to an elastic material configured expand and contract as moved by a body of a person when breathing;
detecting distances of a first optical code from a second optical code to measure breathing of a patient over time;
detecting a time period for a breathing cycle of the patient;
aligning acquired image data sets with the body of the person; and
displaying the acquired image data sets in temporal alignment with the time period for a breathing cycle of the patient based in part on the detected distances between the first optical code and the second optical code over time.

26. The method of claim 25, wherein the elastic material is attached to a belt around the body of the person.

27. The method of claim 25, wherein aligning an acquired image data set having an image visible marker with the body of the person is performed using a third optical code on the body of the person and an image visible marker attached to the third optical code that is aligned with a virtual image visible marker in the acquired image data sets.

28. The method of claim 25 wherein aligning an acquired image data set with the body of the person further comprises aligning the acquired image data set with the body of the person by aligning the acquired image data set with a surface contour of the body of the person or performing manual alignment of the acquired image data set with the body of the person.
